(19) United States
(12) Patent Application Publication
(10) Pub. No.: US 2010/0211977 A1
(43) Pub. Date: Aug. 19, 2010

(54) APPARATUS AND METHOD FOR TRANSMITTING PRESENTATION INFORMATION IN A DIGITAL BROADCAST SYSTEM

(76) Inventors: Jae-Yeon Song, Seoul (KR); Seo-Young Hwang, Gyeonggi-do (KR); Kook-Heui Lee, Gyeonggi-do (KR); Young-Kwon Lim, Gyeonggi-do (KR)

Correspondence Address: THE FARRELL LAW FIRM, LLP, 290 Broadhollow Road, Suite 210E, Melville, NY, 11747, US

(21) Appl. No.: 12/678,239

(22) PCT Filed: Sep. 10, 2008
(86) PCT No.: PCT/KR08/05340

§ 371 Date: Mar. 15, 2010

(30) Foreign Application Priority Data
Sep. 14, 2007 (KR) 10-2007-093869

(51) Int. Cl. H04N 5/445

(52) U.S. Cl. 725/54

(57) ABSTRACT

A method and apparatus is provided for defining and transmitting/receiving a presentation fragment including therein a requirement for a scheme of displaying an Electronic Service Guide (ESG) in a digital broadcast system. The transmission method includes generating a presentation fragment including therein a requirement for terminal presentation; inputting the presentation fragment including therein a requirement for terminal presentation to an ESG data model through encoding; and transmitting the ESG data model to the terminal. The presentation fragment includes ESG's display control information at the terminal.

### BACKGROUND OF THE INVENTION

1. Field of the Invention

The present invention relates generally to a digital broadcast system, and in particular, to an apparatus and method for transmitting and receiving display information of an Electronic Service Guide (ESG) in a digital broadcast system.

2. Description of the Related Art

In general, a digital broadcast system means a system that uses a digital transmission technology in a broadcasting system, such as Digital Audio Broadcasting (DAB), Digital Video Broadcasting (DVB), and Digital Multimedia Broadcasting (DMB).

Among them, the DVB system, a European digital broadcast technology, is a transmission standard for supporting not only the existing digital broadcasting, but also mobile and portable digital multimedia services.

The DVB system can multiplex Moving Picture Experts Group 2 Transport Stream (MPEG2 TS)-based broadcast data, and simultaneously transmit Internet Protocol (IP)-based data streams. Further, in the DVB system, several services can be transmitted after multiplexed to one IP stream, and a terminal can receive data of the transmitted IP stream, demultiplex it back into individual services, demodulate the services and output them on its screen. In this case, the terminal needs information indicating types of the various services provided from the DVB system, and indicating the contents included in the services.

The DVB system uses a service guide, called the ESG to provide information on the services. The ESG data includes time information for a particular service, associated content information, information necessary for receiving the contents, and information necessary for purchasing the contents. Regarding the ESG, for its efficient transmission, the DVB system makes a data model and determines transmission data based thereon.

FIG. 1 is a diagram illustrating the ESG data model.

Each block in FIG. 1 represents a fragment of an ESG. That is, the ESG data model is composed of a service fragment 130, a schedule event fragment 140, a content fragment 150, an acquisition fragment 160, a service bundle fragment 101, a purchase fragment 110, and a purchase channel fragment 120.

The service fragment 130 includes a description of the entire service, the schedule event fragment 140 represents information on services classified by time, and the acquisition fragment 160 includes information that the terminal should acquire to actually receive data. The service bundle fragment 101 includes information on several services bundled into one service, the purchase fragment 110 provides price information used for purchasing the service bundle, and the purchase channel fragment 120 provides information on the system that the terminal should use to acquire a right for the purchase.

The fragments of the data model each can make reference to other fragments. The expression ‘making reference’, as used herein, means that the current fragment provides its associated information using the information transmitted by another fragment. That is, when one service is composed of several contents, the service fragment 130 includes only a description of the entire service, e.g., a name and a language of the service, but does not include a description of the contents transmitted through the service, and it simply makes reference to the content fragment 150 of the corresponding contents. In order for the terminal to acquire a variety of information necessary for receiving the service, for example, to acquire session information used for a transmitted protocol, the terminal can acquire the information by receiving and demodulating the acquisition fragment 160 to which the service fragment 130 is making reference.

The fragments in their reference relationship should have therein IPs of the fragments to which they are making reference. That is, when the service fragment 130 makes reference to a particular content, the service fragment 130 specifies therein an Identifier (ID) of the content fragment 150 to which it makes reference.

The ESG data model is transmitted to the terminal using a separate IP stream at a separate time as compared with the actual data stream. Therefore, a service provider can transmit the information that the terminal should acquire before it actually receive the service, using the ESG data model. In addition, the ESG data model can be used not only for the service guide for programs, but also for various other purposes.

As to the current ESG data model, the foregoing information is provided to the terminal, and the terminal displays the ESG to the user using its ESG browser application, when the user wants it. Therefore, an ESG User Interface (UI) for determining the format in which the terminal displays the ESG to the user was a unique authority of the terminal. That is, the terminal made a screen format so as to place the service title on the top of the screen for each service, display a video clip or an image associated with the corresponding service thereunder, and display schedule information thereunder, or handled the issue of receiving the ESG data model for disposing a preview content on the top of the screen and displaying service title and service price information thereunder, and of determining a screen format in which it will display the information to the user in the ESG browser.

However, the ESG has a very important meaning to the provider, not because the ESG is a file of simply listing only the service-related information in the mobile broadcast service as in the existing TV program guide, but because the ESG is the screen that the user always encounters when he/she starts the mobile broadcast service. Till now, however, there has been no method in which the provider can control how the ESG data model is displayed to the user. That is, for example, when displaying the ESG provided in the World Cup period, the provider can make a request to make the entire background screen red, or if the advertiser for the prime-time zone is Coca Cola™, the provider can make a request to insert a ‘Coca Cola’ logo file into the background screen when displaying service-related information for the prime-time zone on the screen. In addition, in the case where there is a new service that undergoes special promotion, when the user intends to see the corresponding service-related information in the ESG browser, he/she can open a pop-up window to write the promotion details of the corresponding service.

In the conventional technology, for presentation of the ESG, a transmitter should aggregate ESG metadata, make an ESG file, and then encode all scenes according to the scene format in which the ESG is displayed on the screen, using a Rich Media Engine (RME). In this operation, the particular RME engine should always exist in the terminal in order to display an ESG encoded with the RME. However, the general RME engines are very complex in their use, and are very significant in calculation. In addition, in order to encode one ESG file with the RME, an operation time of several days to several months is required. In an intention to reflect the requirements of the provider through display of the ESG, not all of the functions of the RME are needed. As for the general Audio/Video (A/V) service other than the ESG, the transmitter encodes the corresponding service with the RME using such a mechanism, and transmits the results to the terminal. However, the ESG is different in its attributes from the general A/V service file or streaming. That is, since the ESG is information including therein the service provided to the terminal and its associated information, an access point where the service schedule and the service are provided, may be frequently updated. In addition, the foregoing requirements of the providers should be immediately reflected. That is, for example, through ESG display, a pop-up window where an unexpected event is carried out may be opened, or a user survey can be made. For the frequently updated ESG, when the current RME engine's function and business model are taken into account, it is difficult to encode again the ESG one by one, and immediately send it to the terminal. That is, in order to encode the frequently updated ESG with the RME and send it to the terminal, the provider should have an RME encoding tool to immediately reflect the update details. In addition, when characteristics of the frequently updated ESG are taken into consideration, calculation of the RME engine, required for them, also causes a significant problem.

### SUMMARY OF THE INVENTION

An aspect of the present invention is to address at least the problems and/or disadvantages and to provide at least the advantages described below. Accordingly, an aspect of the present invention is to provide a presentation information transmission/reception apparatus and method for efficiently transmitting ESG presentation-related information in which the provider's requirements for ESG display are reflected, in a digital broadcast system.

Another aspect of the present invention is to provide a presentation information transmission/reception apparatus and method for efficiently receiving ESG presentation-related information in which the provider's requirements for ESG display are reflected, in a digital broadcast system.

Further another aspect of the present invention is to provide a presentation information transmission/reception apparatus and method for defining a new fragment in the existing ESG to transmit information necessary for ESG presentation as ESG data in a digital broadcast system.

Further another aspect of the present invention is to provide a presentation information transmission/reception apparatus and method for more efficiently providing display of an ESG at a terminal by transmitting display information of the ESG as data in a digital broadcast system.

According to one aspect of the present invention, there is provided a method for transmitting presentation information to a terminal connected to a predetermined communication network in a digital broadcast system. The transmission method includes generating a presentation fragment including therein a requirement for terminal presentation; inputting the presentation fragment including therein a requirement for terminal presentation to an Electronic Service Guide (ESG) data model through encoding; and transmitting the ESG data model to the terminal. Preferably, the presentation fragment includes ESG's display control information at the terminal.

According to another aspect of the present invention, there is provided a method for receiving presentation information via a terminal connected to a predetermined communication network in a digital broadcast system. The reception method includes decoding encoded data transmitted from a transmitter; extracting a presentation fragment including therein a requirement for terminal presentation as a result of the decoding; and displaying an Electronic Service Guide (ESG) according to information included in the presentation fragment. Preferably, the presentation fragment includes ESG's display control information at the terminal.

According to further another aspect of the present invention, there is provided an apparatus for transmitting presentation information to a terminal connected to a predetermined communication network in a digital broadcast system. The transmission apparatus includes an Electronic Service Guide (ESG) metadata generator for generating a presentation fragment including therein a requirement for terminal presentation; an encoder for inputting the generated presentation fragment including therein a requirement for terminal presentation to an ESG data model through encoding; and a transmission unit for transmitting the ESG data model to the terminal. Preferably, the presentation fragment includes ESG's display control information at the terminal.

According to yet another aspect of the present invention, there is provided an apparatus for receiving presentation information via a terminal connected to a predetermined communication network in a digital broadcast system. The reception apparatus includes an Electronic Service Guide (ESG) processor for extracting a presentation fragment from an ESG data model or ESG announcement carousel information; and a controller for outputting a control signal to an ESG browser using the presentation fragment to perform an ESG display operation. Preferably, the presentation fragment includes ESG's display control information at the terminal.

### BRIEF DESCRIPTION OF THE DRAWINGS

The above and other aspects, features and advantages of the present invention will become more apparent from the following detailed description when taken in conjunction with the accompanying drawings in which:

FIG. 1 is a diagram illustrating an ESG data model;

FIGS. 2A and 2B are diagrams illustrating an ESG data model to which a new presentation fragment is added according to an embodiment of the present invention;

FIGS. 3A to 3F are diagrams illustrating, in XML syntax, an example of information included in a presentation fragment according to an embodiment of the present invention;

FIG. 3G is a diagram hierarchically illustrating the XML syntaxes of FIG. 3A to FIG. 3F;

FIG. 4 is a diagram illustrating another embodiment of FIG. 3D in XML syntax;

FIG. 5 is a diagram illustrating an example of an ESG written using the XML syntax according to an embodiment of the present invention;

FIG. 6 is a diagram illustrating an example of an ESG written in the XML syntax, when the ‘termID’ of FIG. 4 is used;

FIG. 7 is a diagram illustrating a method for transmitting an ESG along with the ‘PresentationVersion’ information of Table 1 and Table 2;

FIG. 8A is a diagram schematically illustrating a structure of a transmitter according to an embodiment of the present invention

FIG. 8B is a diagram schematically illustrating a structure of a receiver according to an embodiment of the present invention;

FIG. 9 is a flowchart illustrating an operation of a transmitter according to an embodiment of the present invention; and

FIG. 10 is a flowchart illustrating an operation of a receiver according to an embodiment of the present invention.

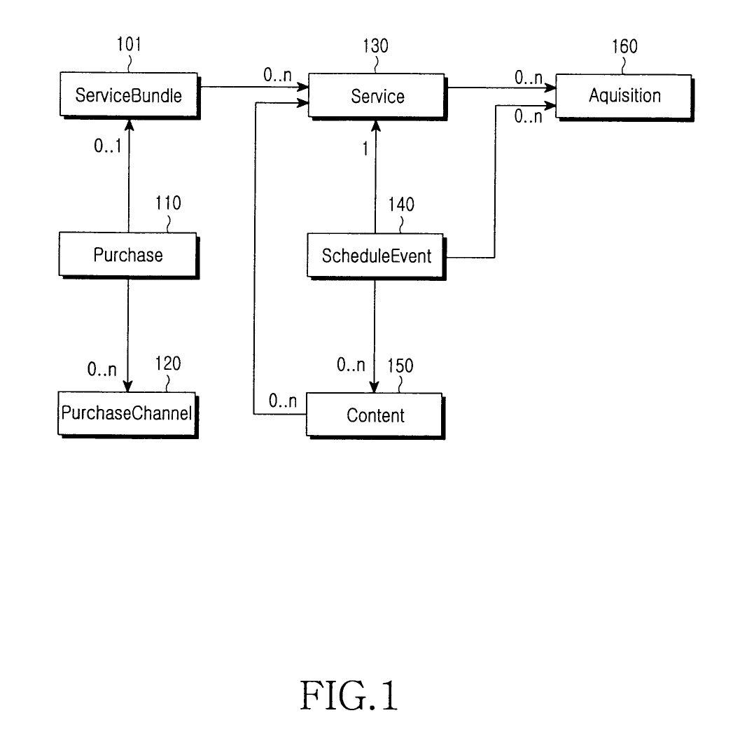

### DETAILED DESCRIPTION OF THE PREFERRED EMBODIMENTS

Preferred embodiments of the present invention will now be described in detail with reference to the annexed drawings. In the following description, a detailed description of known functions and configurations incorporated herein has been omitted for clarity and conciseness. Terms used herein are defined based on functions in the present invention and may vary according to users, operators' intention or usual practices. Therefore, the definition of the terms should be made based on contents throughout the specification.

The present invention inserts presentation-related data in an ESG during its transmission in order to facilitate transmission of presentation information in which characteristics of the frequently updated ESG are reflected, and facilitate immediate reflection of providers' requirements.

The present invention provides an apparatus and method for defining functions whose attributes are frequently used taking characteristics of ESG display into account, among the presentation functions of an RME, as a presentation fragment in an ESG, and transmitting the provider's ESG display-related requirements through the presentation fragment.

Although the present invention will be described with reference to Digital Video Broadcasting (DVB) in the digital broadcast system, by way of example, the same can be applied even to other digital broadcast systems. However, when there is a change in the system to which the present invention is applied, there is a need for switching to the names uniquely used in the corresponding system, and this will not be dealt with herein.

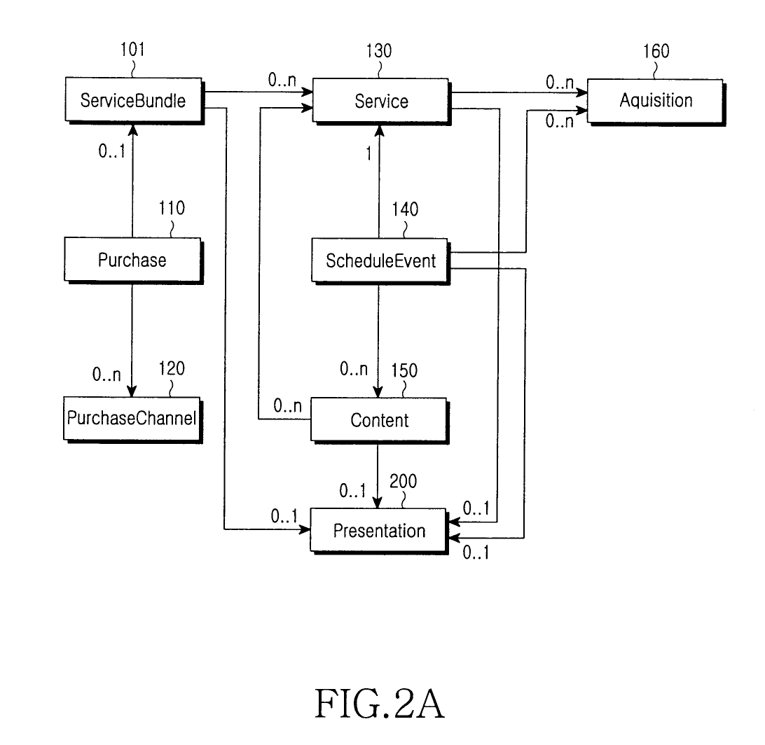

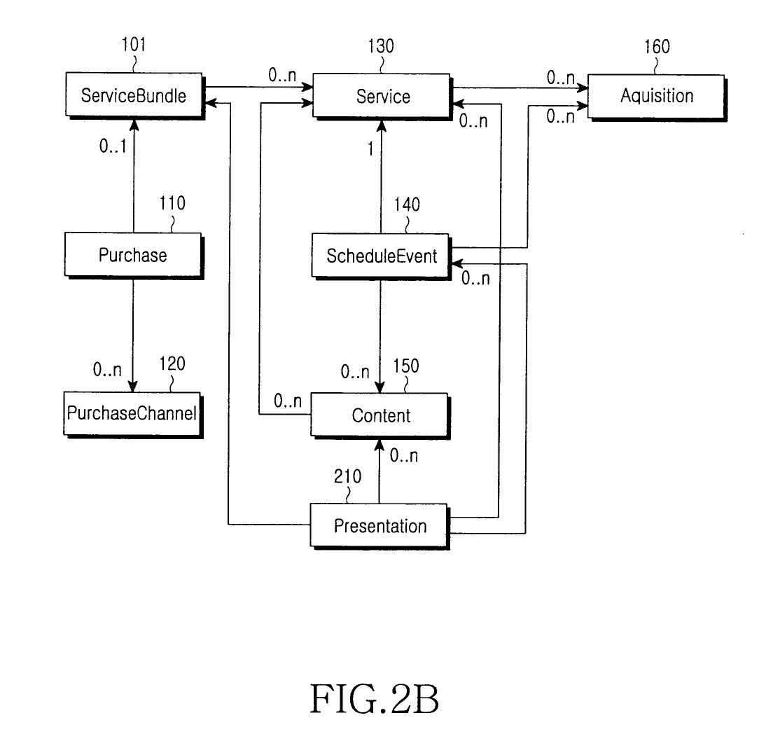

FIG. 2 is a diagram illustrating an ESG data model to which a new presentation fragment is added according to an embodiment of the present invention. The shown ESG data model is divided into FIG. 2A and FIG. 2B according to cardinality between fragments. As to a relation between FIG. 2A and FIG. 2B, they are constructed in different embodiments, or a fragment structure having both cardinalities can also be illustrated by combining FIG. 2A with FIG. 2B. Referring to a presentation fragment 200 of FIG. 2A and/or a presentation fragment 210 of FIG. 2B, it can be understood that a service bundle fragment 101, a schedule event fragment 140, a content fragment 150, and a service fragment 130 each have a reference relationship with the corresponding presentation fragment 200 or 210.

Shown in FIG. 2A is the case to which reference relationship cardinality is applied on the basis of other fragments that make reference to the presentation fragment 200. That is, the cardinality can be defined so that the service fragment 130, the schedule event fragment 140, the content fragment 150, and the service bundle fragment 101 make reference to the presentation fragment 200 in which presentation information associated with the corresponding service is contained. In this case, in the reference relationship, the one or less corresponding fragments can make reference to the presentation fragment 200. That is, since the particular service or schedule event should make reference to the presentation information of the ESG and use it when displaying the ESG, the reference should basically be made by only one or less fragment.

Shown in FIG. 2B is the case to which reference relationship cardinality with other fragments that make reference to the presentation fragment 210 is applied on the basis of the presentation fragment 210. That is, when the same presentation fragment is applied in multiple services, one presentation fragment 210 can make reference to n or less service fragments. In this case, a cardinality connection relationship can be seen in which one presentation fragment 210 has multiple reference relationships to the service fragment 130, the schedule event fragment 140, the content fragment 150 and the service bundle fragment 101.

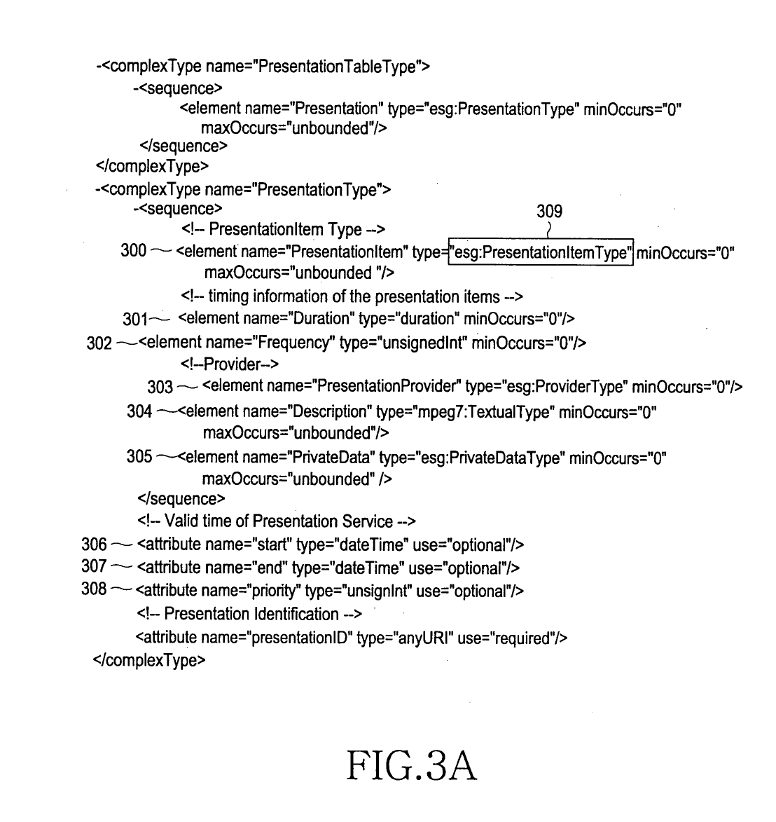

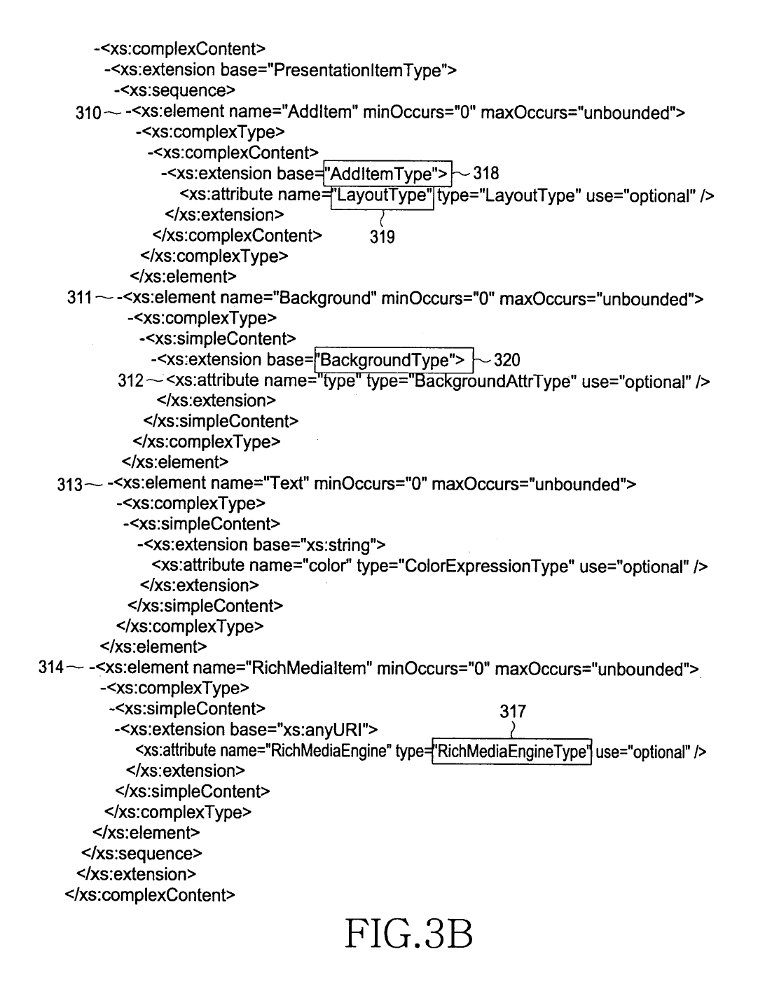

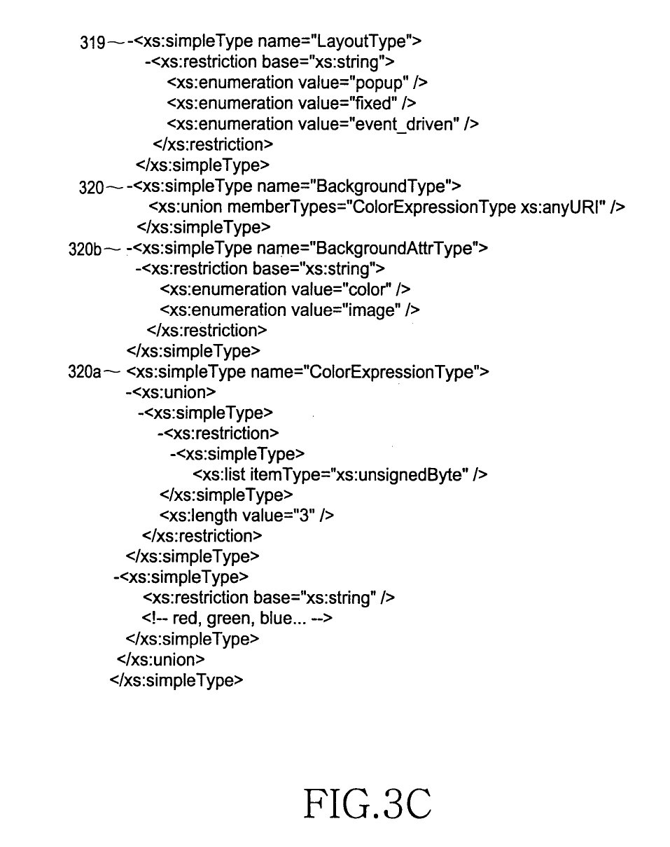

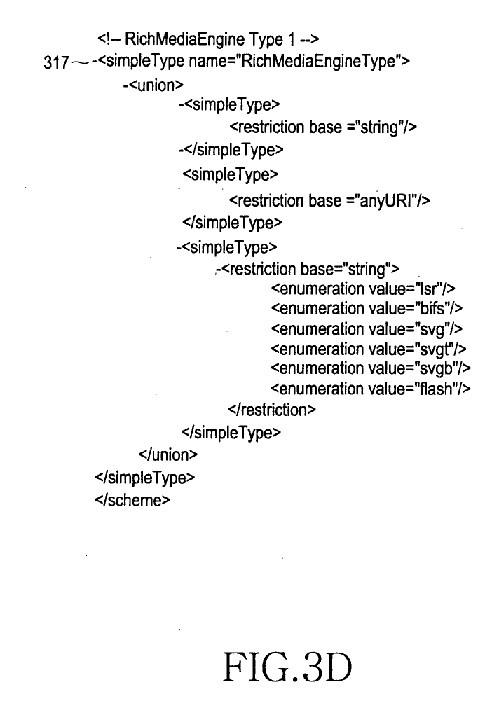

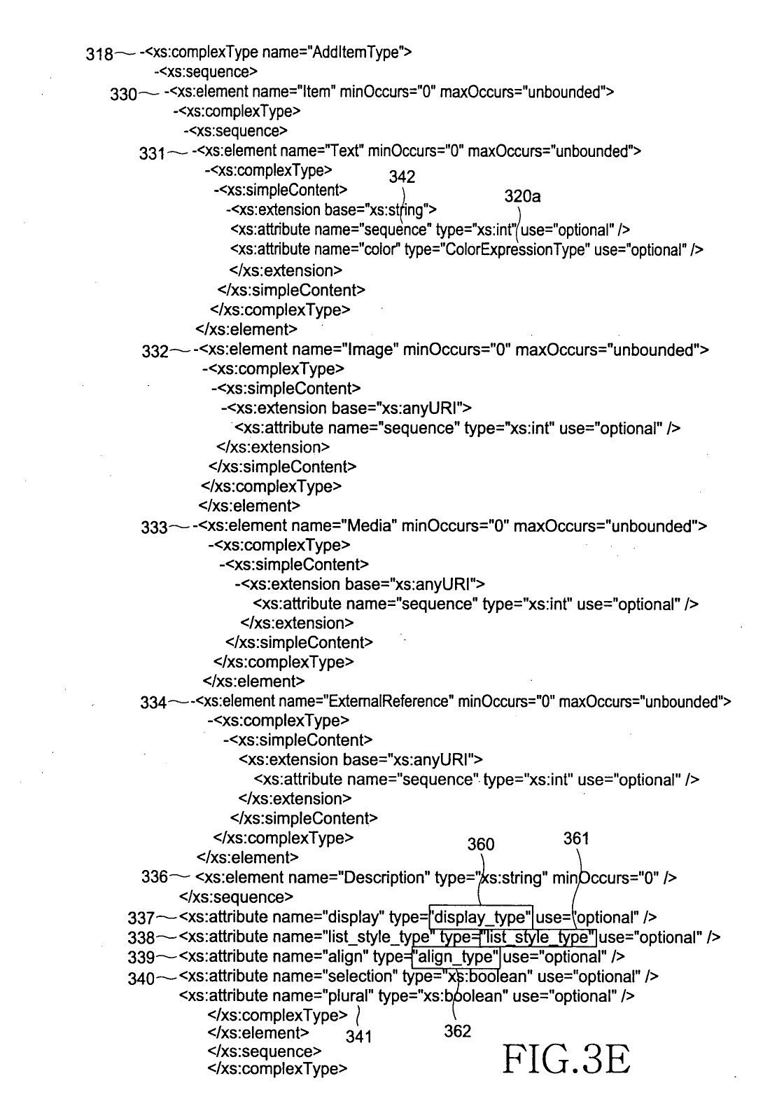

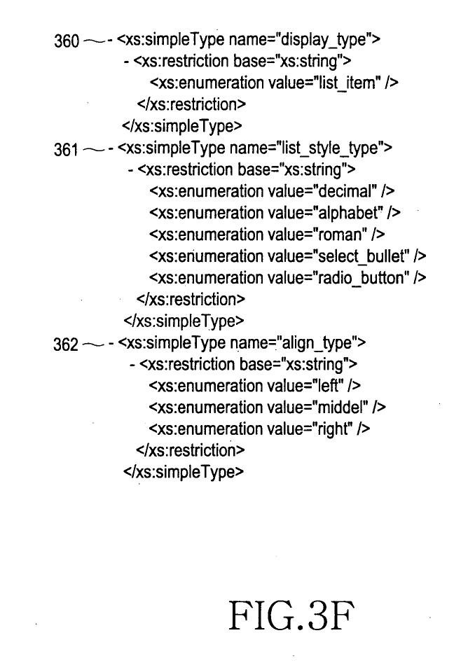

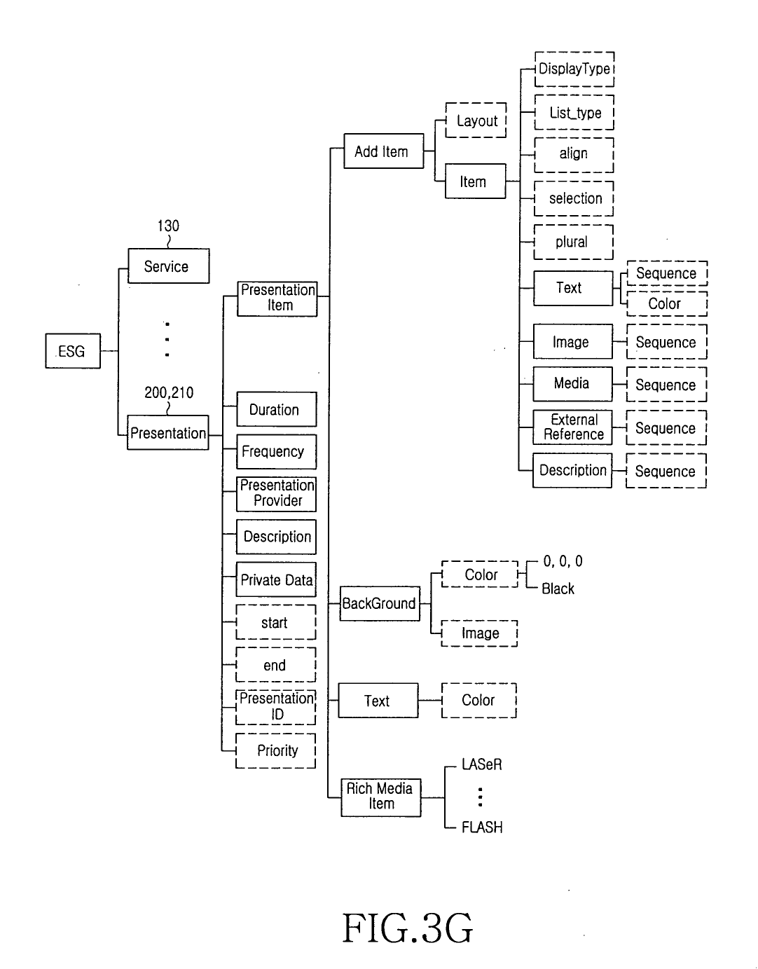

FIGS. 3A to 3F illustrate an embodiment that shows, in XML syntax, information included in a presentation fragment proposed by the present invention. Therefore, the detailed names and data types of the XML syntax, defined in this embodiment, are subject to change without departing from the scope of the present invention.

Referring to FIG. 3A, a ‘PresentationItem’ element 300 is defined that indicates which presentation items are included. A detailed description of the ‘PresentationItem’ element is given in FIG. 3B. ‘PresentationItem’ can define at least one of an item to be displayed in addition to data of the general ESG, a color to be displayed on the background screen, a background file, and a text to be additionally displayed. When the corresponding ESG is encoded with a particular RME, the corresponding information can be displayed. ‘Duration’ 301 means duration for which the corresponding presentation item is to be displayed. ‘Frequency’ 302 represents a frequency of occasions in which the corresponding presentation item is displayed. ‘PresentationProvider’ 303 is information on a provider that provided the corresponding presentation fragment. ‘Description’ 304 includes therein a brief description of the corresponding presentation items, and ‘PrivateData’ 305 can be used when there is an intention to insert particular information that the service provider wants in addition to the above-defined presentation information. ‘start’ 306 and ‘end’ 307 represent information on a start and an end of the time for which the presentation items are displayable. For example, these are used to change the background color only in the particular promotion period, or to open a pop-up window only before a particular service is started. Reference numeral 308 represents, as a ‘priority’ attribute value, priority between presentation fragment items. That is, as for the presentation fragments related to a TV program running from 7 o'clock to 9 o'clock, if there are a presentation fragment connected to a schedule event fragment from 7 o'clock to 9 o'clock and a presentation fragment connected to a service fragment, and if overlapping happens between items of the two presentation fragments, priority should be set between the corresponding items in order for the terminal to display the corresponding items. That is, for example, when different background files are set, a background file related to an advertiser for the corresponding broadcast time zone is high in priority, or when a particular program is displayed according to requirements of the provider, the requirements can exist that should necessarily display a logo file of the corresponding service provider. Generally, the highest priority is assumed to be ‘priority’=0, and the detailed value and rank of the priority are subject to change according to the semantic of the corresponding attribute value. ‘esg:PresentationItemType’ 309 is shown in detail in FIG. 3B. Referring to FIG. 3B, ‘AddItem’ 310 defines the items added over an ESG when it is displayed, like the pop-up window of the logo image file of the service provider. Positions where the items will be displayed and their sizes will be additionally described in detail. ‘Layout’ 319 is an element for defining a layout method for the added items. ‘Background’ 311 is an element for defining a color or a background screen to be designated as a background, and ‘backbroundAttrType’ 312 defines whether the background is a particular color or a background image file. ‘text’ 313 designates a color of a text when the text is added as a presentation element. A font size or a font type of the text can be additionally designated in more detail. ‘RichmediaItem’ 314 is information indicating which RME was used. ‘LayoutType’ 319 and ‘BackgroundType’ 320 of FIG. 3B are shown in detail in FIG. 3C. Referring to FIG. 3C, ‘LayoutType’ 319, an element for defining a layout method for items, defines whether the items will be displayed through a pop-up window, whether the items will be displayed as a part of an ESG screen on a fixed basis, and whether the items will be activated and displayed when an event happens where the user clicks a button. ‘BackgroundType’ 320 is composed of ‘ColorExpressionType’ 320a indicating a method of expressing a color, and ‘backgroundAttrType’ 320b indicating whether the background file is a particular color or an image file. ‘ColorExpressionType’ 320a designates a method of expressing the color with a numeral such as ‘255’ and ‘0’, or with a string such as ‘red’ and ‘blue’. FIG. 3D illustrates RME type denoted by reference numeral 317 of FIG. 3B. That is, the provider can transmit its requirements for ESG display using the presentation fragment, or the provider can fully encode the ESG display scene using a scene generation tool and send it. In this case, it is necessary to inform the terminal of the used scene generation tool (RME) such as MPEG4 Lightweight Application Scene Representation (LASeR) and MPEG4 Binary Format for Scenes (BIFS). In the RME type 317, ‘lsr’ means MPEG4 LASeR, ‘bifs’ means MPEG4 BIFS, ‘svg’ means Scalable Vector Graphics (SVG), ‘svgt’ means SVGTiny, ‘svgb’ means SVGBasic, and ‘flash’ means FLASH, and another tool can also be defined.

‘AddItemType’ denoted by reference numeral 318 of FIG. 3B is illustrated in detail in FIG. 3E. ‘AddItemType’ 318 defines elements for displaying the items added over an ESG when it is displayed. Referring to FIG. 3E, ‘AddItemType’ 318 is composed of added items ‘Item’ 330. ‘Item’ 330 is composed of ‘Text’ 331, ‘Image’ 332, ‘Media’ 333 such as video and audio, ‘ExternalReference’ 334 (e.g., server address) for fetching data or resources for presentation, or for feeding back data, and ‘Description’ 336 including therein a brief description of the corresponding items. ‘Item’ 330 can be used for one screen several times, and it can be composed of any one of the text and the image, or the above several elements can be used together several times. ‘Item’ 330 can have various attributes other than its several constituent elements. A ‘display’ 337 attribute defines in which type the elements constituting ‘Item’ will be displayed. A ‘list Style’ attribute 338, when a type of the ‘display’ 337 of elements constituting ‘Item’ is a list type, defines how to express the list style. An ‘align’ attribute 339 represents an alignment method for the elements constituting ‘Item’, and a ‘selection’ attribute 340, when an interactive service such as voting and game is provided, indicates a need to select one of a voting list and a game list. A ‘plural’ attribute 341, when there is a need to select one of the voting and game lists, defines whether it is possible to select only one list or multiple lists. However, basic values of ‘selection’ and ‘plural’ attributes are determined as ‘false’.

‘Text’ 331 is expressed in a string, and is composed of ‘ColorExpressionType’ 320a representing a color of the string. ‘Image’ 332, and ‘Media’ 333 such as video and audio, can designate positions of the corresponding elements and fetch them. When an interactive service is provided, such as written expression of viewing, in which the user can take part during broadcasting, the terminal can use ‘ExternalReference’ 334 by making external reference to the ‘written expression of viewing’ bulletin board provided by the service provider, or can fetch it by making reference to external resources for the service of browsing a pop-up window of a logo image file of the service provider. The elements constituting ‘Item’ all have a ‘sequence’ attribute 342, and this attribute, when several constituent elements are used together, are provided for expressing sequences of the constituent elements. For example, when ‘sequence’ of a text element is ‘1’ and ‘sequence’ of an image element is ‘2’, this item should be made so that the image is expressed after the text. If the text and image elements are all ‘3’ in ‘sequence’, the two elements can be expressed together in the corresponding sequence. In addition, one preface is attached to ‘list_style’ per sequence number. For example, when text and image are both ‘1’ in the voting service, one select button is expressed for the corresponding text and image. ‘display_type’ 360, list_style_type' 361, and ‘align_type’ 362 are illustrated in detail in FIG. 3F. Referring to FIG. 3F, ‘display_type’ 360, which defines in which type the elements constituting ‘Item’ will be displayed, can be expressed in the list type, and various types can be added. When a ‘display’ type of the elements constituting ‘Item’ is the list type, the ‘list_style_type’ 361 defines in which method it will express the list style. The list style can be expressed with numeral, alphabet, roman letter, select button, radio button etc., and other various styles can be added. An ‘align’ attribute 339, which represents an alignment method, defines right alignment, center alignment, and left alignment.

FIG. 3G is a diagram hierarchically illustrating the XML syntaxes of FIG. 3A to FIG. 3F. That is, an ESG is composed of the service fragment 130 through the presentation fragment 200 (210), and when the item subject to presentation, i.e., an item for an interactive service including the pop-up window, the background screen, the text, and the ESG are encoded with RME, the presentation fragment 200 (210) proposed by the present invention can be roughly divided into an element indicating a type of the used RME engine; information related to the time for which presentation items such as Duration, Frequency, Start and End are displayed; Priority information for multiple presentation items; and identification information of the presentation information, such as provider information, description, presentationID, and private data. In FIG. 3G, the solid-line boxes represent elements and the dotted-line boxes represent attributes. For example, ‘Background’ has one of ‘color’ and ‘image’ attributes, and the ‘color’ attribute can have an element displaying a value of the color in the form of ‘0.0.0’, or can express it in ‘black’.

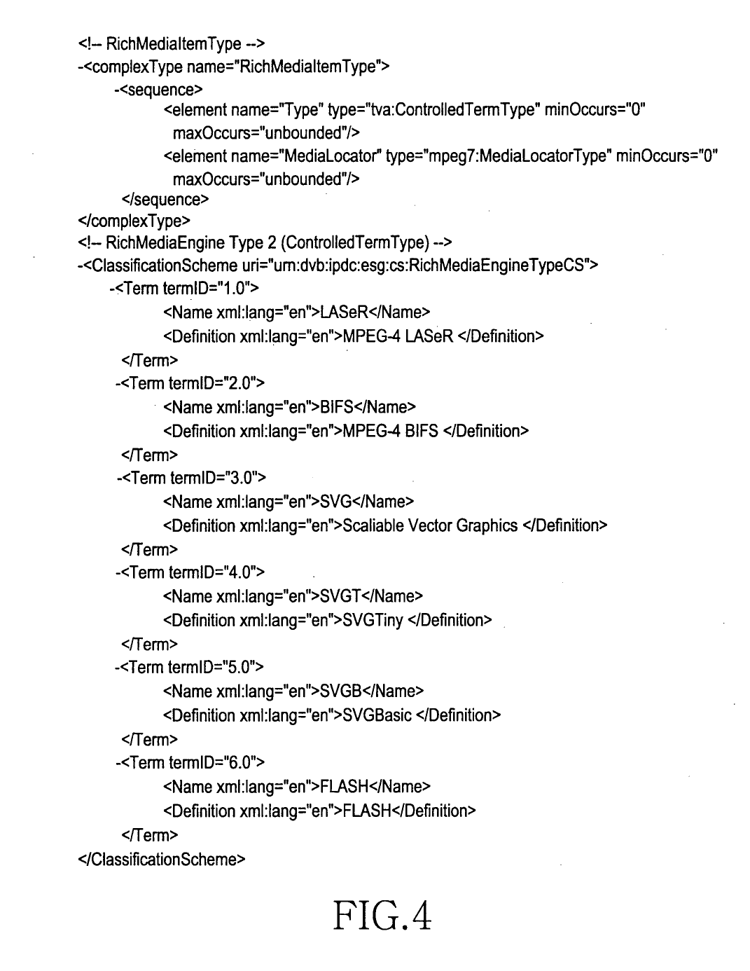

FIG. 4 illustrates, as another embodiment of FIG. 3D, a type of a used scene generation tool using Classificationscheme rather than using a scheme for selecting one of <union> . . . </union> as in FIG. 3D. When the Classificationscheme scheme is used, since a corresponding Uniform Resource Identifier (URI) is declared in ‘urn:dvb:ipdc:esg:cs:RichMediaEngineTypeCS’, the continuous update is possible later.

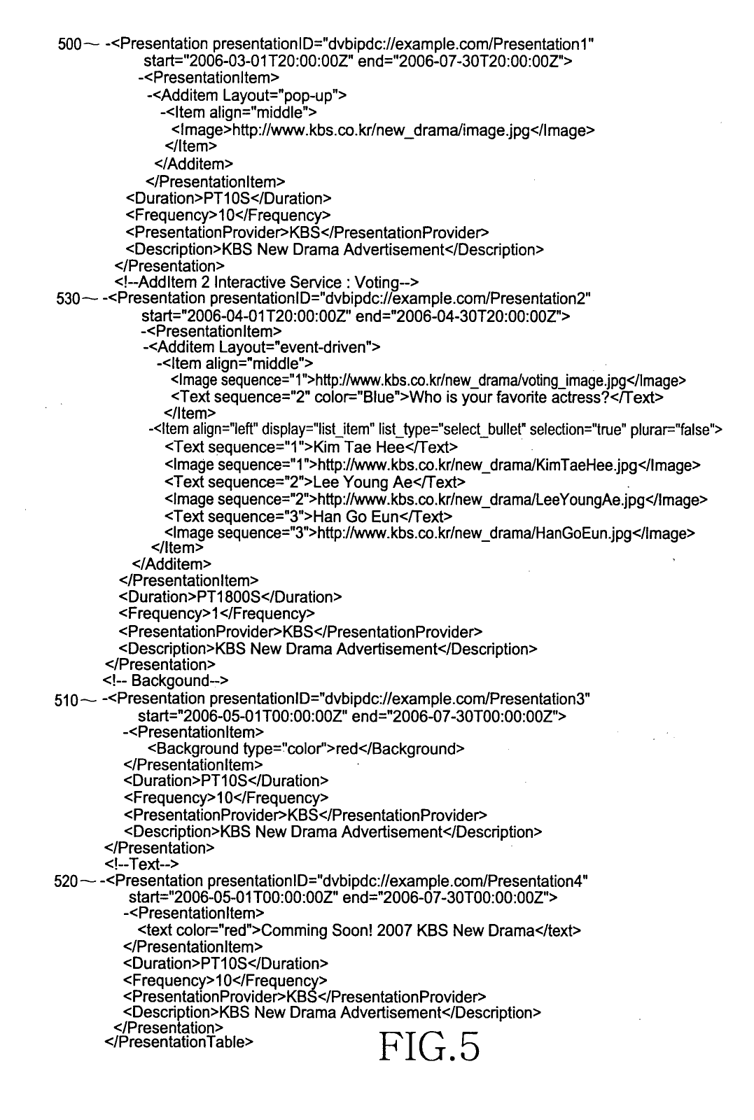

FIG. 5 illustrates an example of an ESG written using the XML syntax according to an embodiment of the present invention. Referring to FIG. 5, reference numerals 500, 510, and 520 represent examples of their different presentation fragments, and theses are shown in one drawing, for convenience.

According to reference numeral 500, when a particular service or a service in a particular time zone is displayed in an ESG browser, an image file of ‘http://www.kbs.co.kr/new_drama/image.jpg’ is displayed on a pop-up window for 10 seconds, and since a ‘frequency’ value is ‘10’, the image file is displayed up to 10 times in the displayable time of the corresponding presentation item, set by ‘start’ and ‘end’.

According to reference numeral 510, other parts are equal to the corresponding parts of reference numeral 500, and only the part for setting the background color rather than image.jpg as ‘red’ is different.

According to reference numeral 520, there is shown the case where string is inserted, and it is shown that a color of the string is ‘red’ and the contents of the string is ‘Coming Soon! 2007 KBS New Drama’.

According to reference numeral 530, there is shown a voting service which is one of the interactive services. The voting service is set to be displayed only once for 30 minutes, and since its layout type is an ‘event-driven’ type, the voting service is displayed when an event happens in which the user clicks a button. The title of the voting is subject to center alignment, and the text ‘Who is your favorite actress?’ is displayed in ‘blue’ color under an image of ‘http://www.kbs.co.kr/new_drama/Voting_image.jpg’. Since the voting list item is set as ‘list_item’, the items are displayed in the list type, and since it is necessary to select an item(s), a ‘selection’ attribute is set as ‘true’, and a ‘plural’ attribute is set as ‘false’, it is possible to select only one of the lists. The voting list is basically subject to left alignment, a string ‘Kim Tae Hee’ and ‘http://www.kbs.co.kr/new_drama/KimTaeHee.jpg’ are expressed together in the same line, and a select button is displayed in front of the item. The other lists are also set to be displayed in order in the same manner.

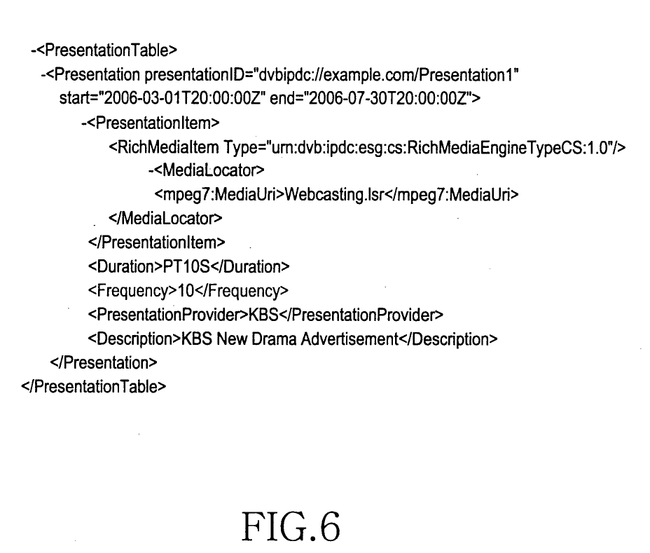

FIG. 6 illustrates an example of an ESG for the case where the ‘termID’ of FIG. 4 is used.

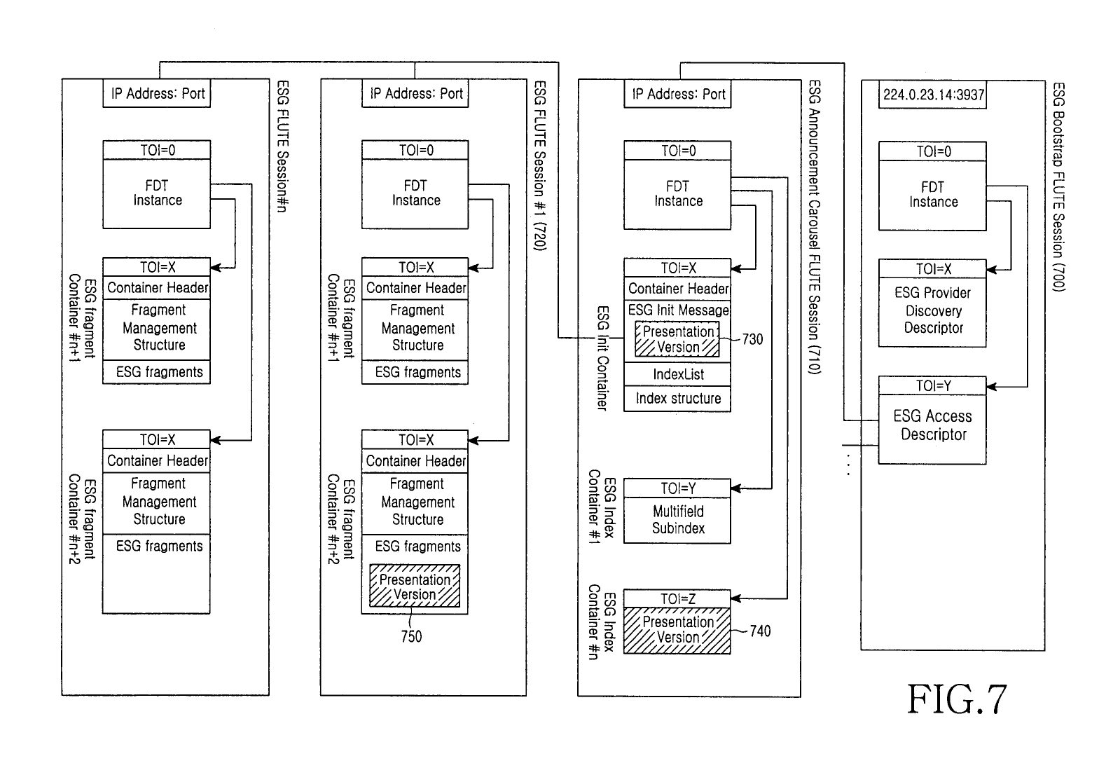

Referring to FIG. 6, there is shown an example of ‘LASeR’ which is defined in ‘urn:dvb:ipdc:esg:cs:RichMediaEngineTypeCS:1.0’ using ‘termID=1.0’. This is used when the provider encodes and sends the scene format during ESG display using a particular RME tool instead of the presentation items defined in the presentation fragment as described above. It can be understood that a file obtained by encoding a corresponding ESG using an ‘LASeR’ RME language defined in ‘urn:dvb:ipdc:esg:cs:RichMediaEngineTypeCS:1.0’ can be transmitted with Webcasting.lsr. Table 1, Table 2 and FIG. 7 are embodiments illustrating a method for inserting the corresponding information into an announcement carousel during ESG transmission, instead of the method for inserting information on the use of the RME into the ESG data model in FIG. 3D or FIGS. 4 and 6. The other presentation fragment parts except for the use of the RME are equal to the foregoing embodiment. Table 1 shows an ESG init message defined in the European Telecommunications Standards Institute (ETSI) TS 102 471 ESG specification, which is extended for insertion of presentation information. Referring to Table 1, the ESG init message is defined in place of the RME information for an ESG, defined in FIGS. 3D and 4, by inserting ‘PresentationVersion’ information in the existing init message. Table 2 gives definitions of values of the ‘PresentationVersion’, and the values are basically equal to the values defined in FIGS. 3D and 4. These values are obtained by listing up the RME specifications currently defined as the international standard, and their details are subject to change as the new standards are established.

TABLE 1

| Syntax | No. of bits | Mnemonic |
|---|---|---|
| ESG init Message { | | |
| EncodingVersion | 8 | uimsbf |
| PresentationVersion | 8 | uimsbf |
| IndexingFlag | 1 | bslbf |
| reserved | 7 | |
| Decoderiniptr | 8 | bslbf |
| if(IndexingFlag) { | | |
| IndexingVersion | 8 | uimsbf |
| } | | |
| if(Encoding Version == ‘0xF1’) { | | |
| BufferSizeFlag | 1 | bslbf |
| PositionCodeFlag | 1 | bslbf |
| Reserved | 8 | |
| CharacterEncoding | 8 | uimsbf |
| If(BufferSizeFlag == ‘1’) { | | |
| BufferSize | 24 | uimsbf |
| } | | |
| } | | |
| if(EncodingVersion == ‘0xF2’) \|\| | | |
| EncodingVersion == ‘0xF3’) { | | |
| CharacterEncoding | 8 | uimsbf |
| } | | |
| Reserved | 0 or 8+ | |
| Decoderinit( ) | | bslbf |
| } | | |

TABLE 2

| Value | Encoding Version |
|---|---|
| 0x00 | MPEG4 LASeR |
| 0x01 | MPEG4 BIFS |
| 0x02 | SVG |
| 0x03 | SVGT |
| 0x04 | SVGB |
| 0x05 | FLASH |
| 0xF6 | User defined |
| 0xF7 | Reserved |

FIG. 7 illustrates a method for transmitting an ESG along with the ‘PresentationVersion’ information of Table 1 and Table 2.

An ESG bootstrap session denoted by reference numeral 700 includes therein ‘ESG Provider Discovery Descriptor’ containing ESG provider-related information, and ‘ESG Access Descriptor’ through which access information (IP address, port) is transmitted for a particular ESG.

‘ESG announcement FLUTE session’ denoted by reference numeral 710 is a separate session containing the information that ‘ESG Access descriptor’ can accesses for each particular ESG. In this session are transmitted an ESG encoding scheme determined by receiving an ESG; ESG fragment ID information contained in a container which is a transmission unit of the ESG; and configuration information of each IP flow when the ESG is transmitted through several divided IP flows. The present invention extends the ‘ESG announcement FLUTE session’ 710 and transmits the ‘ESG init message’ of Table 1 in the form shown by reference numeral 730. Also, it is possible to define only the ‘PresentationVersion’ information other than ‘ESG Init Container’ in the new container (740).

Reference numeral 720 shows ‘ESG FLUTE session’ for each IP flow when one ESG is transmitted through multiple IP flows as stated above.

Reference numeral 750 shows an embodiment where the ‘PresentationVersion’ information exists in a presentation fragment of the ESG data model. Therefore, in other embodiments, if the ‘PresentationVersion’ information is transmitted in the ESG announcement carousel, RichMediaItem among the constituent elements of the presentation fragment in FIG. 3G is omitted.

A description will now be made of structures of a transmitter and a receiver according to an embodiment of the present invention.

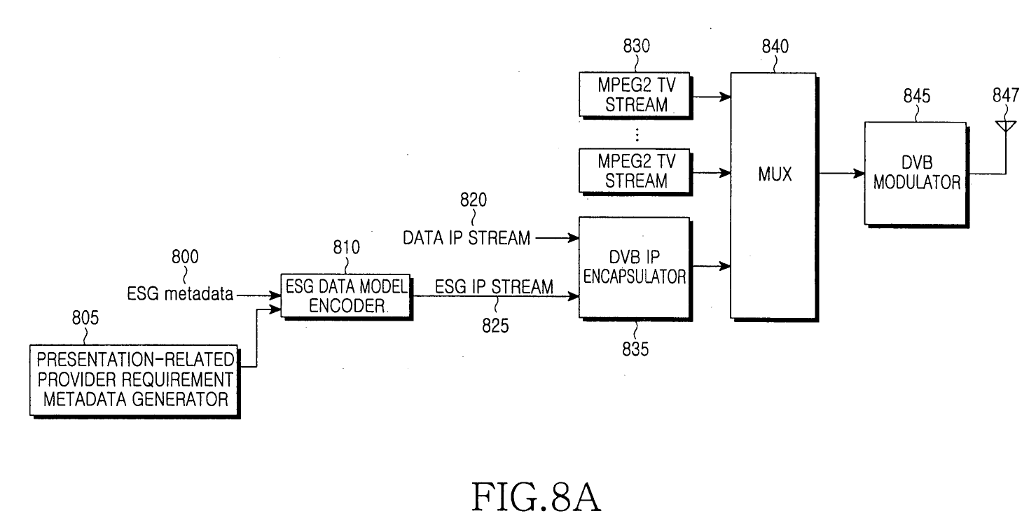

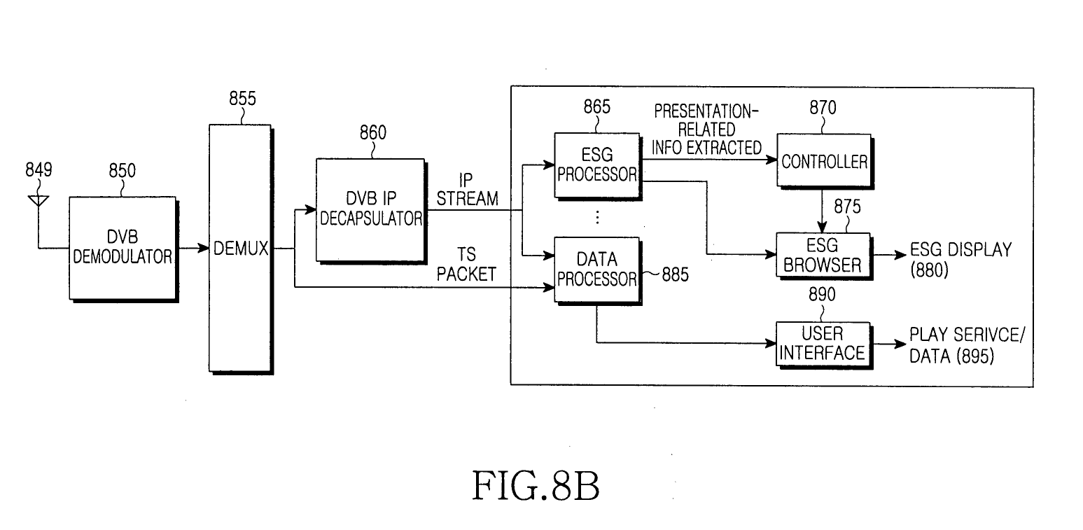

FIG. 8A is a diagram schematically illustrating a structure of a transmitter according to an embodiment of the present invention.

Referring to FIG. 8A, a presentation-related provider requirement metadata generator 805, as proposed by the present invention, generates presentation-related provider requirement metadata and stores it. The presentation-related provider requirement metadata includes the presentation fragment 200 or 201 of FIG. 3G. The presentation-related provider requirement metadata generator 805 can include a separate memory to store the generated presentation-related provider requirement metadata. The presentation-related provider requirement metadata generated by the presentation-related provider requirement metadata generator 805 and ESG metadata 800 excluding it are input to an ESG data model encoder 810. Then the ESG data model encoder 810 inputs the presentation-related provider requirement metadata and the ESG metadata 800 to an ESG data model through encoding, and outputs an ESG IP stream 825. The ESG IP stream 825 and another data IP stream 820 are both input to a DVB IP encapsulator 835. The DVB IP encapsulator 835 encapsulates the ESG IP stream 825 and the data IP stream 820 into an MPEG2 Transport Stream (TS), and then inputs it to a multiplexer 840 along with another MPEG2 TV stream 830 which is a TV stream. The multiplexer 840 multiplexes the MPEG2 transport streams. The multiplexed MPEG2 transport streams are input to a DVB modulator 845. The DVB modulator 845 modulates the multiplexed MPEG2 transport streams into Orthogonal Frequency Division Multiplexing (OFDM) symbols, and then transmits the OFDM symbols to a receiver via an antenna 847.

FIG. 8B is a diagram schematically illustrating a structure of a receiver according to an embodiment of the present invention.

Referring to FIG. 8B, a signal received via an antenna 849 is input to a DVB demodulator 850. The DVB demodulator 850 performs OFDM demodulation on the received signal. The OFDM-demodulated data is input to a demultiplexer 855. The demultiplexer 855 demultiplexes the OFDM-demodulated data into IP-encapsulated packet and MPEG2 TS packet.

The TS packet is input to a data processor 885, and the data processor 885 performs a process necessary for displaying the corresponding service to the user interface 890.

On the other hand, the IP-encapsulated packet is input to a DVB IP decapsulator 860, and the DVB IP decapsulator 860 decapsulates the IP-encapsulated packet back into the IP stream. The IP stream is divided back into an ESG stream and a data stream. The data stream is input to the data processor 885 together with the TS packet, and the data processed in the data processor 885 is input to the user interface 890 and then provided to the user (895). The ESG stream is input to an ESG processor 865. According to an embodiment of the present invention, the ESG processor 865 extracts ESG presentation-related information from the ESG data model or the ESG announcement carousel information, and inputs it to a controller 870. The ESG information except for the ESG presentation information is input to an ESG browser 875. The controller 870 sends a control signal to the ESG browser 875 using the provided presentation information, and performs an ESG display operation (880) of changing a pop-up window added when the ESG is displayed to the user, a provider's logo file, or a background screen set by default, according to the requirements of the provider.

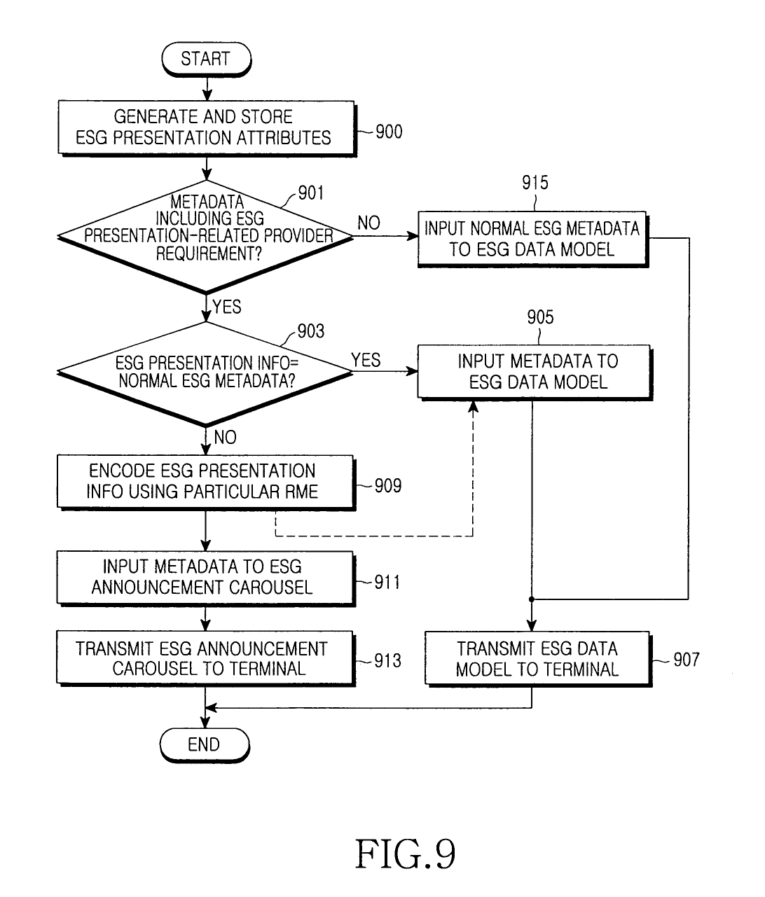

FIG. 9 is a flowchart illustrating an operation of a transmitter according to an embodiment of the present invention.

Referring to FIG. 9, in step 900, the transmitter generates ESG presentation attributes in which requirements for the frequently-updated terminal presentation are reflected, and stores them in a memory.

Thereafter, the transmitter determines in step 901 whether input metadata is metadata in which ESG presentation-related provider requirements are included. If the input metadata is metadata in which the ESG presentation-related provider requirements are included, the transmitter determines in step 903 whether the ESG presentation information is normal ESG metadata. If the ESG presentation information is normal ESG metadata, the transmitter inputs the metadata to the ESG data model through encoding in step 905. Thereafter, in step 907, the transmitter transmits the ESG data model to a receiver.

However, if the ESG presentation information is not normal ESG metadata in step 903, the transmitter encodes the ESG presentation information using a particular RME in step 909. Thereafter, the transmitter can process the ESG presentation information encoded using the particular RME in the following two methods.

In a first method, the transmitter inputs the ESG presentation information encoded using the particular RME to the ESG data model in step 905, and transmits the ESG data model to the receiver in step 907.

In a second method, the transmitter inputs the ESG presentation information encoded using the particular RME to an ESG announcement carousel in step 911, and transmits the ESG announcement carousel to the receiver in step 913.

However, if it is determined in step 901 that the input metadata is not the metadata in which the ESG presentation-related provider requirements are included, i.e., if the input metadata is normal ESG metadata other than ESG presentation-related information, the transmitter inputs the normal ESG metadata to the ESG data model in step 915, and transmits the ESG data model to the receiver in step 907.

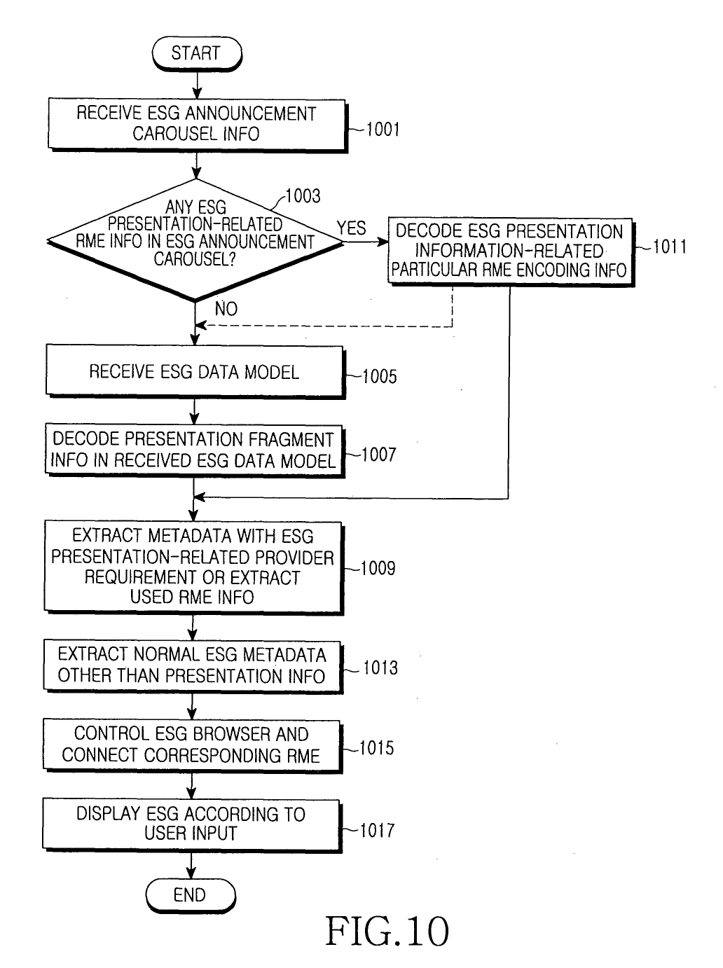

FIG. 10 is a flowchart illustrating an operation of a receiver according to an embodiment of the present invention.

Referring to FIG. 10, the receiver receives ESG announcement carousel information in step 1001, and determines in step 1003 whether there is any ESG presentation-related RME information in the ESG announcement carousel information.

If there is no ESG presentation-related RME information in the ESG announcement carousel information, the receiver receives an ESG data model in step 1005, and decodes presentation fragment information in the received ESG data model in step 1007. As a result of the decoding, the receiver extracts, in step 1009, metadata including therein ESG presentation-related provider requirements, or extracts RME information. Thereafter, the receiver extracts normal ESG metadata other than ESG presentation information in step 1013, and controls an ESG browser using the ESG presentation information in step 1015. In step 1017, if the terminal wants to display an ESG, the receiver drives a corresponding ESG browser to display the ESG or drives an RME according to the received presentation-related information.

However, if it is determined in step 1003 that there is ESG presentation-related RME information in the ESG announcement carousel information, the receiver decodes ESG presentation information-related particular RME encoding information in step 1011. After the decoding, the receiver can perform the following two methods.

In a first method, the receiver receives the ESG data model in step 1005, and decodes presentation fragment information in the received ESG data model in step 1007. As a result of the decoding, the receiver extracts metadata including therein ESG presentation-related provider requirements or extracts the used RME information in step 1009. Thereafter, the receiver extracts the normal ESG metadata other than the ESG presentation information in step 1013, and controls an ESG browser and connects a corresponding RME application using the ESG presentation information in step 1015. In step 1017, if the terminal issues a request to display an ESG, the receiver drives a corresponding ESG browser to display the ESG or drives an RME according to the received presentation-related information.

In a second method, the receiver extracts metadata including therein ESG presentation-related provider requirements or extracts the used RME information in step 1009. Thereafter, the receiver extracts normal ESG metadata other than the ESG presentation information in step 1013, and controls an ESG browser and connects a corresponding RME application using the ESG presentation information in step 1015. In step 1017, if the terminal wants to display an ESG, the receiver drives a corresponding ESG browser 875 to display the ESG or drives an RME according to the received presentation-related information.

In sum, according to the present invention, in providing an ESG, the digital broadcast system generates and transmits a presentation fragment including therein provider's requirements for a scheme of displaying the ESG, so the provider can control how the ESG is displayed at the terminal through the ESG data model.

As is apparent from the foregoing description, according to the present invention, in providing an ESG, the digital broadcast system defines and transmits a presentation fragment including therein provider's requirements for a scheme of displaying the ESG, so the provider can control display of the terminal through an ESG data model.

In addition, according to the present invention, the digital broadcast system can efficiently transmit ESG presentation-related information in which provider's requirements for ESG display are reflected.

Further, according to the present invention, the digital broadcast system can efficiently receive ESG presentation-related information in which provider's requirements for ESG display are reflected.

Moreover, according to the present invention, the transmitter can transmit display information of an ESG as data, and the receiver can more efficiently provide display of an ESG.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method for transmitting presentation information to a terminal connected to a predetermined communication network in a digital broadcast system, the method comprising:
generating a presentation fragment including therein a requirement for terminal presentation;
inputting the presentation fragment including therein a requirement for terminal presentation to an Electronic Service Guide (ESG) data model through encoding; and
transmitting the ESG data model to the terminal;
wherein the presentation fragment includes ESG's display control information at the terminal.

2. The method of claim 1, wherein the presentation fragment comprises:
a PresentationItem element indicating at least one of an item to be displayed in addition to data of a general ESG, a color or background file to be displayed on a background screen, and a text to be additionally displayed;
a Duration element indicating duration for which the PresentationItem is to be displayed;
a Frequency element indicating a frequency of occasions in which the PresentationItem is displayed;
a PresentationProvider element indicating information on a provider that provided the presentation fragment;
a Description element indicating a brief description of the PresentationItem;
a PrivateData element indicating particular information that the service provider wants in addition to the above-defined presentation information;
start and end attributes indicating a start and an end of a time for which the PresentationItem is displayable, respectively;
a priority attribute indicating a priority between the presentation fragment items; and
a presentationID attribute indicating identification information of the presentation fragment.

3. The method of claim 2, wherein when the ESG is encoded with a particular Rich Media Engine (RME), the PresentationItem further comprises RichmediaItem indicating which RME is used.

4. The method of claim 3, wherein when presentation version information is included in an ESG announcement carousel during transmission, the RichmediaItem is omitted.

5. The method of claim 1, further comprising:
storing the generated presentation fragment including therein a requirement for terminal presentation.

6. The method of claim 1, wherein the requirement for terminal presentation includes a provider's requirement.

7. The method of claim 1, further comprising:
inputting, to an ESG announcement carousel, ESG presentation information encoded using a particular RME during the encoding; and
transmitting the ESG announcement carousel to the terminal.

8. The method of claim 7, further comprising:
inputting, to the ESG data model, ESG presentation information encoded using the particular RME; and
transmitting the ESG data model to the terminal.

9. A method for receiving presentation information via a terminal connected to a predetermined communication network in a digital broadcast system, the method comprising:
decoding encoded data transmitted from a transmitter;
extracting a presentation fragment including therein a requirement for terminal presentation as a result of the decoding; and
displaying an Electronic Service Guide (ESG) according to information included in the presentation fragment;
wherein the presentation fragment includes ESG's display control information at the terminal.

10. The method of claim 9, wherein the presentation fragment comprises:
a PresentationItem element indicating at least one of an item to be displayed in addition to data of a general ESG, a color or background file to be displayed on a background screen, and a text to be additionally displayed;
a Duration element indicating duration for which the PresentationItem is to be displayed;
a Frequency element indicating a frequency of occasions in which the PresentationItem is displayed;
a PresentationProvider element indicating information on a provider that provided the presentation fragment;
a Description element indicating a brief description of the PresentationItem;
a PrivateData element indicating particular information that the service provider wants in addition to the above-defined presentation information;
start and end attributes indicating a start and an end of a time for which the PresentationItem is displayable, respectively;
a priority attribute indicating a priority between the presentation fragment items; and
a presentationID attribute indicating identification information of the presentation fragment.

11. The method of claim 10, wherein when the ESG is encoded with a particular Rich Media Engine (RME), the PresentationItem further comprises RichmediaItem indicating which RME is used.

12. The method of claim 11, wherein when presentation version information is included in an ESG announcement carousel during transmission, the RichmediaItem is omitted.

13. The method of claim 9, wherein extracting a presentation fragment including therein a requirement for terminal presentation comprises:
receiving ESG announcement carousel information;
determining whether there is any ESG presentation-related RME information in the ESG announcement carousel information;
receiving an ESG data model when there is no ESG presentation-related RME information in the ESG announcement carousel information; and
decoding a presentation fragment in the ESG data model, and extracting a presentation fragment in which an ESG presentation-related provider requirement is included, as a result of the decoding.

14. The method of claim 13, further comprising:
when there is ESG presentation-related RME information in the ESG announcement carousel information, decoding ESG presentation information-related particular RME encoding information; and
receiving the ESG data model, and decoding a presentation fragment in the received ESG data model to extract a presentation fragment in which an ESG presentation-related provider requirement is included.

15. The method of claim 13, further comprising:
when there is ESG presentation-related RME information in the ESG announcement carousel information, extracting a presentation fragment in which an ESG presentation-related provider requirement is included, or extracting used RME information.

16. An apparatus for transmitting presentation information to a terminal connected to a predetermined communication network in a digital broadcast system, the apparatus comprising:
an Electronic Service Guide (ESG) metadata generator for generating a presentation fragment including therein a requirement for terminal presentation;
an encoder for inputting the generated presentation fragment including therein a requirement for terminal presentation to an ESG data model through encoding; and
a transmission unit for transmitting the ESG data model to the terminal;
wherein the presentation fragment includes ESG's display control information at the terminal.

17. The apparatus of claim 16, wherein the presentation fragment comprises:
a PresentationItem element indicating at least one of an item to be displayed in addition to data of a general ESG, a color or background file to be displayed on a background screen, and a text to be additionally displayed;
a Duration element indicating duration for which the PresentationItem is to be displayed;
a Frequency element indicating a frequency of occasions in which the PresentationItem is displayed;
a PresentationProvider element indicating information on a provider that provided the presentation fragment;
a Description element indicating a brief description of the PresentationItem;
a PrivateData element indicating particular information that the service provider wants in addition to the above-defined presentation information;
start and end attributes indicating a start and an end of a time for which the PresentationItem is displayable, respectively;
a priority attribute indicating a priority between the presentation fragment items; and
a presentationID attribute indicating identification information of the presentation fragment.

18. The apparatus of claim 17, wherein when the ESG is encoded with a particular Rich Media Engine (RME), the PresentationItem further comprises RichmediaItem indicating which RME is used.

19. The apparatus of claim 18, wherein when presentation version information is included in an ESG announcement carousel during transmission, the RichmediaItem is omitted.

20. The apparatus of claim 16, further comprising:
a memory for storing the generated presentation fragment including therein a requirement for terminal presentation.

21. An apparatus for receiving presentation information via a terminal connected to a predetermined communication network in a digital broadcast system, the apparatus comprising:
an Electronic Service Guide (ESG) processor for extracting a presentation fragment from an ESG data model or ESG announcement carousel information; and
a controller for outputting a control signal to an ESG browser using the presentation fragment to perform an ESG display operation;
wherein the presentation fragment includes ESG's display control information at the terminal.

22. The apparatus of claim 21, wherein the presentation fragment comprises:
a PresentationItem element indicating at least one of an item to be displayed in addition to data of a general ESG, a color or background file to be displayed on a background screen, and a text to be additionally displayed;
a Duration element indicating duration for which the PresentationItem is to be displayed;
a Frequency element indicating a frequency of occasions in which the PresentationItem is displayed;
a PresentationProvider element indicating information on a provider that provided the presentation fragment;
a Description element indicating a brief description of the PresentationItem;
a PrivateData element indicating particular information that the service provider wants in addition to the above-defined presentation information;
start and end attributes indicating a start and an end of a time for which the PresentationItem is displayable, respectively;
a priority attribute indicating a priority between the presentation fragment items; and
a presentationID attribute indicating identification information of the presentation fragment.

23. The apparatus of claim 22, wherein when the ESG is encoded with a particular Rich Media Engine (RME), the PresentationItem further comprises RichmediaItem indicating which RME is used.

24. The apparatus of claim 23, wherein when presentation version information is included in an ESG announcement carousel during transmission, the RichmediaItem is omitted.
